(19) United States
(12) Patent Application Publication
(10) Pub. No.: US 2011/0101686 A1
(43) Pub. Date: May 5, 2011

(54) COUPLING CONSTRUCTION FOR HIGH-PRESSURE PIPE

(75) Inventors: Lambertus Gerrit Peter DALMOLEN, Amsterdam (NL); Peter Jeroen CLOOS, Enkhuizen (NL); Lennert Johannes BAKKER, Enkhuizen (NL)

(73) Assignee: PIPELIFE NEDERLAND B.V., Enkhuizen (NL)

(21) Appl. No.: 12/609,908

(22) Filed: Oct. 30, 2009

(51) Int. Cl. F16L 21/00; F16L 25/00

(52) U.S. Cl. 285/398; 285/423

(57) ABSTRACT

A coupling construction includes a coupling (1) and at least one high-pressure pipe (2) connected to the coupling. The high-pressure pipe includes an external revetment layer (3), a reinforcement layer (4) as well as an internal liner (5). The coupling furthermore includes a load transfer element (9, 10) which engages the external revetment layer (3), as well as a sealing (6, 14) which engages the liner (5). The reinforcement layer (4) includes a braided material (7, 8) whereby the external revetment layer (3) engages the braided material (7, 8) in such a way that shear forces can be transferred in a reliable way. A further advantage is that the load transfer element (9, 10) of the coupling (1) is positioned only on the outside of the pipe (2), as a result of which the internal volume of the pipe is free of flow restrictions.

The invention is related to a coupling construction, comprising a coupling and at least one high-pressure pipe connected to said coupling, which high-pressure pipe comprises an external revetment layer, a reinforcement layer as well as an internal liner and wherein the coupling comprises a load transfer element which engages the external revetment layer, as well as a sealing which engages the liner.

Such a coupling construction is generally known. The coupling thereof has the purpose of transferring forces which occur in the pipe wall when a high-pressure medium, such as a gas or a liquid, is being transported through the pipe. In the pipe itself, these forces are borne by the reinforcement layer within the pipe wall. It is thus of the utmost importance that, in order to ensure a proper transfer of forces which occur in the pipe wall, a reliable and strong connection is obtained between the coupling and said reinforcement layer.

According to a prior art coupling construction, this is achieved by providing a connection between the reinforcement layer and the outer revetment layer through a bonding means such as an adhesive. As the revetment layer itself is connected to the coupling, for instance by melting said layer to a plastic coupling sleeve, a load path is provided between the coupling and the reinforcement layer of the pipe. The disadvantage of such connection is however the rather high costs thereof. The manufacturing process is cumbersome, and requires specialists skills.

The coupling construction described before is for instance applied in combination with pipes which comprise several wound layers of tape with unidirectional fibers embedded therein. It is not possible to obtain a firm connection between the outer wound layer of the pipe wall and the coupling without the step of gluing or melting the coupling sleeve to said layer. In the absence of such connection, the coupling sleeve and the pipe would simply slip and unwind with respect to each other in the direction of the wound fibers.

According to yet another prior art method, the pipe wall is squeezed between an outer sleeve and an inner sleeve of the coupling. The inner sleeve, which usually is a steel sleeve so as to provide the required resistance and thereby the required squeeze force, however reduces the inner dimensions of the pipe which has a negative effect on the capacity thereof. Moreover, such sleeve is prone to corrosion, depending on the medium which is being transported.

The object of the invention is therefore to provide a coupling construction for a high-pressure pipe which does not have the disadvantages associated with the prior art coupling constructions, such as complicated construction lay-outs, expensive manufacturing processes and limited capacities, while still providing a reliable and strong connection. This object is achieved in that the reinforcement layer comprises a braided material, in that the external revetment layer engages said braided material, and in that the load transfer element of the coupling is restricted to the outside of the pipe.

The combination of features according to the invention, that is the braided character of the reinforcement layer, the cooperation of the external revetment layer with said braided reinforcement layer, and also the coupling connected to the revetment layer, surprisingly lead to an extraordinary force transfer between the pipe and the coupling. This advantageous effect first of all relies on the specific texture of a braided product, which in itself has a certain surface structure which is not smooth but instead has raised and lowered parts. The external revetment layer which is extruded onto such braided layer, will conform itself in the still hot state after extrusion onto this uneven surface of the braided layer. Thereby a firm bond is obtained between the external revetment layer and the reinforcement layer, which in particular has a high shear resistance.

Once the coupling is reliably connected to said outer revetment layer, force transfer can take place between the coupling and the reinforcement layer through the outer revetment layer. It is not necessary to provide a glue or melt connection between the reinforcement layer and the outer revetment layer, nor is it necessary to squeeze the pipe wall between a sleeve within the pipe and a sleeve on the outside of the pipe. Thereby, surprisingly a strong and reliable connection is obtained between the coupling and the pipe.

The braided reinforcement layer may be carried out in several forms, such as with steel wires. However, preference is given to a braided reinforcement layer comprising synthetic fibers, such as polyester and aramid. Furthermore, at least one of the external and internal layers comprises a thermoplastic resin, in particular polyethylene and polyamide (11 or 12) and PVDF. Such layers can be welded quite well, both for obtaining a seal in the inner layer and for obtaining a firm connection between the outer layer and the coupling. In particular, in the latter case the load transfer element of the coupling comprises an electrically welded sleeve.

In an alternative embodiment, the load transfer element may comprise a shell which clamps the external revetment layer. For instance, the shell may comprise two shell halves which are held pressed onto the external revetment layer. According to a further alternative, the load transfer element may comprise a metallic crimp sleeve. All these embodiments have in common that the load transfer element is positioned on the outside of the pipe only, no load transfer element being present or necessary on the inside of the pipe.

The coupling construction according to the invention may be applied for interconnecting two aligned pipes, or for connecting a pipe to a vessel and the like through a flange construction.

The invention is furthermore related to a method for manufacturing a coupling construction described before, said method comprising the steps of:
providing a liner and a braided reinforcement layer on the outside of the liner, said braided reinforcement layer having an outer surface with raised and lowered parts,
extruding a revetment layer onto the braided reinforcement layer while making the revetment layer material conform to the raised and lowered parts of the outer surface of the braided reinforcement layer,
connecting coupling to the revetment layer.

The invention will now be described further with reference to an embodiment shown in the drawings.

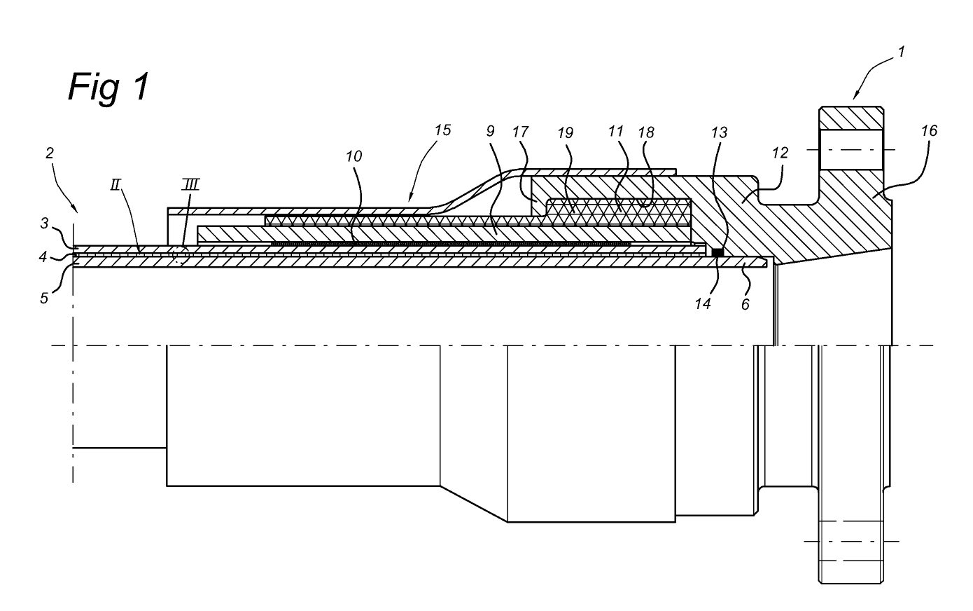

FIG. 1 shows a side view, partially in longitudinal section, of the coupling construction according to the invention.

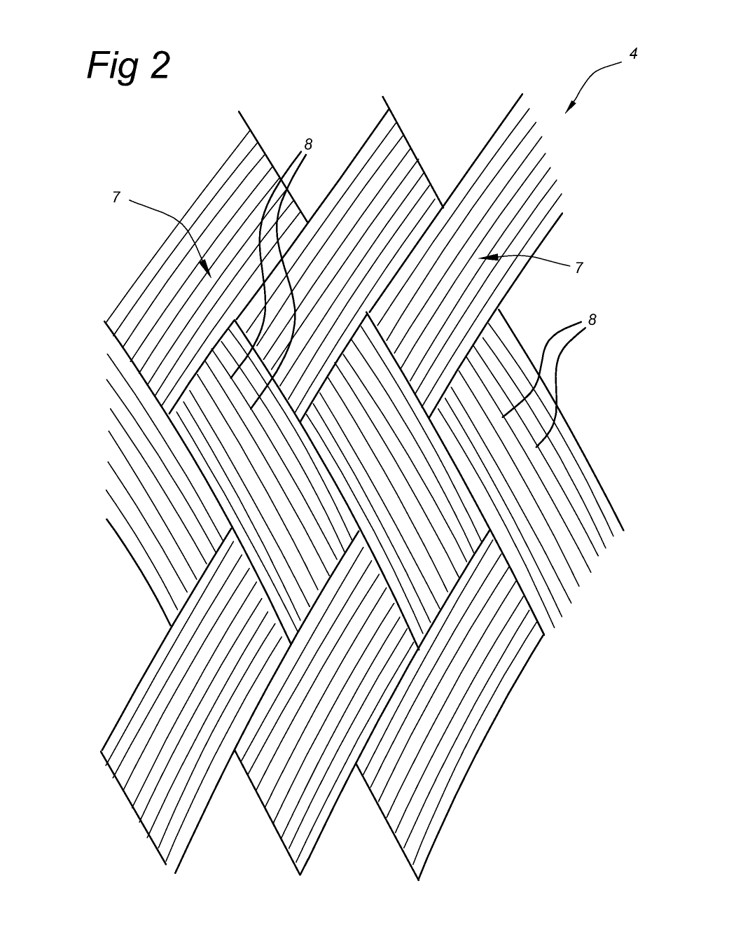

FIG. 2 shows the view according to II of FIG. 1.

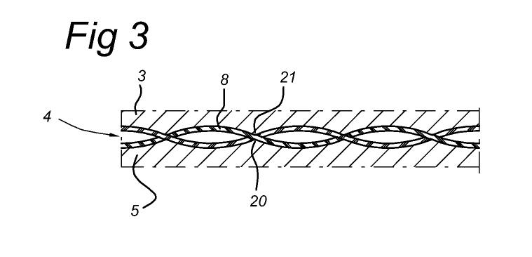

FIG. 3 shows detail III of FIG. 1.

The coupling construction as shown in FIG. 1 consists of a coupling generally denoted by reference numeral 1 and a high-pressure pipe denoted by reference 2. Said high-pressure pipe 2 consists of the external revetment layer 3, the reinforcement layer 4 and the internal liner 5. The internal liner 5 has a somewhat protruding end 6, which provides a seal with respect to the coupling 1 as will be discussed below.

The reinforcement layer 4 consists of a braided material, as is clear from FIG. 2 which shows the detail according to II of FIG. 1. Said braided material, in this example, consists of sets 7 which are braided or weaved into each other and which each contain a number of threads 8. Thus, as shown in FIG. 3, the braided material has an uneven surface 21 with raised and lowered parts, as defined by the shape of the sets 7 and the threads 8.

By extruding molten material onto such braided material, the melt will protrude into the cavities and deeper parts thereof and will conform fully to the uneven, external shape 21 of said braided material and obtain a corresponding uneven surface 20 as shown in FIG. 3. As a result, after solidifying of the extruded molten material which forms the revetment layer 3, a firm connection is obtained through the interlocking character of the revetment layer 3 and the reinforcement layer 4, which connection is in particular suitable for transferring shear forces, that is forces parallel to the length direction of the pipe 2 and the coupling 1.

Said coupling 1 has a coupling body 12 which at one end is provided with the outwardly pointing flange 16 as well as the inwardly pointing rim 17 at the other end. The flange 16 is to be connected to either a corresponding flange of another pipe coupling or of a vessel and the like. The inwardly pointing rim 17 defines an undercut cavity 18 within which the intermediate coupling element 11, in particular the outwardly protruding part 19 of relatively large diameter thereof, is held. Furthermore, the coupling 1 comprises a sleeve 9 which on the inside is provided with heating wires 10. The sleeve 9 is connected to the intermediate layer 11, for instance by means of forms which engage into each other, or by means of bonding or gluing etc. Said coupling body 12 has an internal groove 13, which accommodates a sealing ring 14 which provides a seal with respect to the protruding part 6 of the liner 5.

By heating the heating wires 10, the coupling 1 is firmly connected to the revetment layer 3. This revetment layer 3 in turn is firmly connected to the braided reinforcement layer 4, as a result of which the coupling 1 and the pipe 2 are reliably connected to each other. Pulling forces which try to pull apart the pipe 2 and the coupling 1, resulting from an internal overpressure in the pipe, are transferred from the reinforcement layer 4, through the revetment layer 3, the sleeve 9 and the coupling member 11 onto the rim 17 of the coupling body 12 and the flange 16. The corresponding forms of the braided material of the reinforcement layer 4 and of the revetment layer 3, with parts which protrude into each other, play an important role in this force transfer. The connection area between the coupling 1 and the pipe 2 is finally covered by a crimp sleeve 15.

### LIST OF REFERENCE NUMERALS

1. Coupling
2. Pipe
3. Revetment layer
4. Reinforcement layer
5. Liner
6. Protruding part of liner
7. Sets of wires of reinforcement layer
8. Threads of reinforcement layer
9. Weld sleeve
10. Heating wires
11. Coupling element
12. Coupling body
13. Internal groove coupling body
14. Sealing ring
15. Crimp sleeve
16. Flange of coupling
17. Inwardly protruding rim of coupling element
18. Undercut cavity of coupling element
19. Outwardly protruding part of coupling element
20. Unevenly shaped surface of sleeve
21. Unevenly shaped surface of braided material

1. Coupling construction, comprising a coupling (1) and at least one high-pressure pipe (2) connected to said coupling, which high-pressure pipe comprises an external revetment layer (3), a reinforcement layer (4) as well as an internal liner (5) and wherein the coupling comprises a load transfer element (9, 10) which engages the external revetment layer (3), as well as a sealing (6, 14) which engages the liner (5), characterized in that the reinforcement layer (4) comprises a braided material (7, 8), in that the external revetment layer (3) engages said braided material (7, 8), and in that the load transfer element (9, 10) of the coupling (1) is restricted to the outside of the pipe (2).

2. Coupling construction according to claim 1, wherein the braided reinforcement layer (7, 8) comprises high-strength synthetic fibers (7), such as polyester and aramid fibers.

3. Coupling construction according to claim 1, wherein at least one of the external and internal layers (3, 5) of the pipe (2) comprises a thermoplastic resin.

4. Coupling construction according to claim 1, wherein the load transfer element (9, 10) of the coupling (1) comprises an sleeve (9) which is electrically welded to the pipe (2).

5. Coupling construction according to claim 4, wherein the sleeve (9) comprises, or cooperates with, heating wires (10).

6. Coupling construction according to claim 1, wherein the load transfer element comprises a shell which clamps the external revetment layer.

7. Coupling construction according to claim 6, wherein the shell comprises two shell halves which are held pressed onto the external revetment layer.

8. Coupling construction according to claim 1, wherein the load transfer element comprises a metallic crimp sleeve.

9. Coupling construction according to claim 1, wherein the sealing (14) of the coupling is restricted to the internal liner (5) of the pipe (2).

10. Coupling construction according to claim 9, wherein the sealing comprises an internal sealing sleeve, e.g. positioned within the internal liner.

11. Coupling construction according to claim 1, comprising two aligned pipes (2) which each cooperate with the coupling (1).

12. Coupling construction according to claim 11, wherein the inner linings (5) of the pipes (2) are sealed with respect to each other by means of a sealing sleeve or a mirror weld or butt weld.

13. Coupling construction according to claim 1, wherein the coupling (1) comprises a flange (16) for connection to a pipe stub, such as a pipe stub connected to a vessel.

14. Coupling construction according to claim 1, wherein the revetment layer (3) is conformed to the braided material (7, 8) with forms (20, 21) which engage each other or which protrude into each other.

15. Method for producing a coupling construction according to claim 1, comprising the steps of:
providing a liner (5) and a braided reinforcement layer (4) on the outside of the liner, said braided reinforcement layer having an outer surface with raised and lowered parts,
extruding a revetment layer (3) onto the braided reinforcement layer (4) while making the revetment layer material conform to the raised and lowered parts of the outer surface of the braided reinforcement layer,
connecting the coupling (1) to the revetment layer (3).

16. Method according to claim 15, comprising the steps of:
providing a coupling (1) having a sleeve (9) with electrically heatable wires (10),
applying the sleeve (9) around the revetment layer (3),
applying an electric current to the electrically heatable wires (10) so as the least partially melt the sleeve (9) and the revetment layer (3),
making the material of the sleeve (9) and the revetment layer (3) solidify at least partially so as to establish a connection between the sleeve and the revetment layer.

17. Coupling construction according to claim 2, wherein at least one of the external and internal layers (3, 5) of the pipe (2) comprises a thermoplastic resin.
